(19) United States
(12) Patent Application Publication
(10) Pub. No.: US 2008/0314844 A1
(43) Pub. Date: Dec. 25, 2008

(54) Non-metallic oxygen-releasing canister for use in wells

(75) Inventor: Craig Intelisano, Bradenton, FL (US)

Correspondence Address: Novak, Druce & Quigg LLP, 1300 I Street, N.W., Suite 1000, West Tower, WASHINGTON, DC, 20005, US

(73) Assignee: CONCURRENT TECHNOLOGIES INTERNATIONAL LLC, Bradenton, FL (US)

(21) Appl. No.: 11/812,440

(22) Filed: Jun. 19, 2007

(51) Int. Cl. C02F 1/72

(52) U.S. Cl. 210/758; 210/205; 422/211

(57) ABSTRACT

The invention is a non-metallic, preferably, plastic container for delivering oxygen generating materials (OGMs) into wells. By constructing the canister of a plastic and sealing the ends, the canister can be disposable or reusable.

### BACKGROUND

1. Field of the Invention

The invention is a canister for releasing oxygen into water, such as groundwater, for example in wells, wastewater, drinking water, and swimming pools, and other natural and man-made bodies of water. By providing a non-metallic canister, such as a plastic and disposable canister for the oxygen-releasing material, significant advantages can be realized over conventional systems.

2. Background of the Invention

Groundwater is often contaminated with petroleum or other volatile organic carbons (VOCs), often as result of leaking underground storage tanks (LUSTs). Many of these LUSTs were removed since the 1970's. However, in many of these former sites, VOCs are still detected at significant levels.

Oxygen can be used to clean up many types of VOCs. Native microorganisms utilize, often dissolved, oxygen as an electron acceptor, and the targeted contaminant can serve as the electron donor, resulting in its destruction. Accordingly, oxygen can be used for organic constituents amenable to aerobic biodegradation processes to clean up a variety of contaminants, including: (1) petroleum hydrocarbons; (2) polycyclic aromatic hydrocarbons (PAHs); and (3) benzenes, toluenes and xylenes (BTEX). Oxygen is also used to stimulate aerobic biodegradation through nutrient delivery to the microorganisms.

Typically, oxygen is delivered into groundwater systems by introducing an oxygen-generating material (OGM) into the groundwater. Suitable OGMs include mixtures of peroxides (e.g., calcium peroxide), hydroxides (e.g., calcium hydroxide) and hydrated aluminosilicates (e.g., sodium, calcium aluminosilicates), optionally mixed in a weight ratio, respectively, of 45-70:10-20:20-30. Such a material is a white solid (optionally in powder form), having a bulk density of 500-650 g/L, and is insoluble in water. The OGM can be mixed with water, e.g., to form a slurry (approximately 10-60%, typically 10-20% and preferably approximately 20% solids), before being introduced to the groundwater. Many of such OGM are provided with nutrients, such that the microorganisms can feed and grow on the nutrients, as well as pH buffers, to help to ensure a desirable environment for the microorganisms.

In many of such systems, the OGM is not mixed with water before being added to the groundwater, but is contained in a metal canister for introducing the OGM to the groundwater in its solid state. Thus, the mixing occurs inside the well (“downhole”), whereby the groundwater comes into contact with the solid OGM, as opposed to a slurry. Often, the OGM is contained in a reusable metal canister, having a diameter slightly less than the wellhole, e.g., approximately 2″ or approximately 4″ and a length of between 12″ and 48″, typically approximately 36″.

These reusable metal canisters can damage the well and associated apparatii. Often, electrical and electronic devices are located downhole in the vicinity of the OGM-containing canisters and are powered or otherwise connected to components outside the well. Thus, the metal canisters often come into contact with the wires connecting the downhole devices to the outside components. Because metals can be corrosive and/or abrasive, the contact between the canister and the wires can result in abrading of any insulation on the wires and eventual shorting of the devices and/or components, as many of the metals used to form the canisters are electrically conductive.

Moreover, the devices are often suspended downhole by ropes or cables, and if such cables are not specifically constructed of an abrasion resistant material, the same action which can result in damage to the wires can also cause degradation of the suspension cable and possible loss of the device.

Many metals are also chemically reactive to chemicals used downhole, significantly limiting the types of metals which can suitably be used to form the canisters.

Finally, should one desire to re-use the metal canisters, it would be necessary to decontaminate the canister to ensure that no cross-contamination of other wells occurs.

### SUMMARY OF THE INVENTION

In order to address the drawbacks of other systems for oxygenating groundwater, the present invention includes a disposable non-metallic plastic canister for delivering an OGM to the groundwater. The invention is described for use with groundwater. However, it is understood that the invention can be used with any type of water or more generally any fluid, for example, described herein.

The canister can be of any type of plastic, but is preferably of a relatively inexpensive non-reactive or inert material, such as polyvinyl chloride (PVC), flouropolymers, such as polytetraflouroethylene (PTFE) or an olefin (e.g., polypropylene or polyethylene) and copolymers and blends thereof. The canister can have a multi-layer structure, such as a main structural part of a first plastic, and a coating of a second plastic. The canister 10 can be of a rigid shape or can be flexible.

The canister 10 preferably has an inner space for receiving the OGM, and is designed to allow the OGM to contact the groundwater. This can be accomplished by providing the canister with one or more apertures (e.g., holes, slits, or irregularly shaped openings) permitting the water to enter the canister. In such a configuration, the canister is largely closed, with, optionally, only the spaced holes penetrating the canister and the large holes on the top and bottom of the canister. Alternatively, the canister can be more open, e.g., almost as a mesh, permitting the water to flow therethrough. The particular size/shape of the holes/mesh should be dependent upon the specific condition of the OGM, e.g., solid mass, powder, flakes, etc.

In some embodiments, it is desirable to have the OGM in a liner or sleeve of woven, felted or non-woven fabric which is placed inside the canister. The requirements for the liner or sleeve is that it permits water to contact the OGM contained therein and has openings of such a size as to retain the OGM therein, especially where the OGM is in a powder or flake form.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a schematic representation of a canister in accordance with the invention;

FIG. 2 is a schematic representation of a second canister in accordance with the invention.

### DETAILED DESCRIPTION OF THE PREFERRED EMBODIMENTS

Initially, it is to be understood that like numbers in different drawings indicate similar structures. In the interests of brevity and in order to focus on the distinctions between the different drawings/embodiment, unless specifically discussed, when a particular feature is described as being used or usable in one embodiment, such a feature can be used or useable in other embodiments.

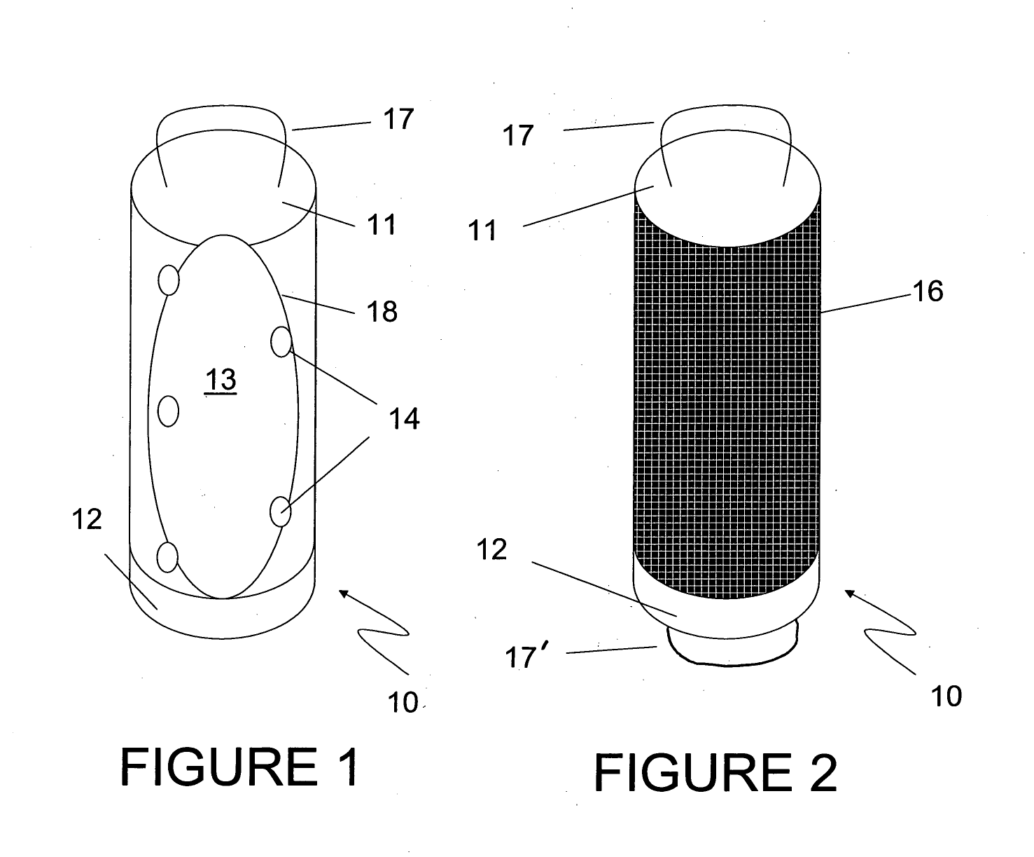

FIG. 1 shows a first canister 10 in accordance with the invention. The canister is typically substantially cylindrical in shape, having a top 11 and a bottom 12, separated by a middle section or body 13. Although shown as being a perfect cylinder, i.e., with the top 11 and bottom 12 being flat, planar structures defining parallel planes and the canister having a completely circular cross-section of a constant diameter across its length, the canister 10 of the present invention is not so limited. For example, the canister 10 can have a cross-section (either at a single location or uniform along the length of the canister 10) in the shape of any closed, regular or irregular polygon, e.g., square, hexagon, rectangle, triangle, and pentagon.

For example, the canister 10 can have any shape sufficient to hold OGM disposed therein. While the shape of the canister 10 is preferably a closed three-dimensional structure, it is considered within the scope of the invention to provide the canister 10 with other, e.g., non-uniform shapes, allowing for greater flow of groundwater through the canister 10. In such an embodiment, the diameter of the circular cross-section could increase or decrease across the height of the canister 10.

In order to oxygenate groundwater into which the canister 10 is placed, the top 11, bottom 12 and body 13 define an interior space into which material is placed. Typically, such material is an oxygen-generating material (OGM) which can be mixed with other materials, such as nutrients, pH buffers or other chemicals (e.g., surfactants, salts—such as salts of sodium, chlorine, and potassium, and halogens, chlorinators, bleaches, softeners, and ozone-generating materials) designed to interact with the water, microorganisms and other downhole materials.

In the embodiment shown in FIG. 1, the body 13 is provided with apertures 14. Although shown as being regularly spaced and substantially circular, the invention is certainly not so limited, as any repeating or non-repeating pattern is suitable. The body 13 can include any number of apertures 14, e.g., from one to thousands. The apertures 14 need also not be circular. For example, the apertures 14 can be of any regular or irregular polygonal shape, e.g., square and hexagonal. The apertures 14 may also consist of an elongated slit which extends, preferably only part-way, horizontally between the top 11 and the bottom 12, vertically between the top 11 and the bottom 12 or at any angle therebetween. The size, shape, number and position of the one or more apertures 14 largely depends upon the physical form of the OGM, as will be described below.

In order to achieve the advantages of the present invention, at least the body 13 of the canister is formed from a non-metallic, preferably plastic, material. Typically, the plastic is a thermoplastic material, such as polyvinyl chloride (PVC), an olefin (such as polyethylene, polypropylene, and polybutylene), copolymers thereof and blends thereof. The plastic material can also be of any density, e.g., HDPE, LDPP, etc., as the material can be foamed (open cell or closed cell), extruded, or molded. The canister 10 may also be produced from more than one type of plastic (either as a blend, or as separate pieces joined together), and one or more different types of materials (in combination with a plastic material).

In a most preferred embodiment, the top 11 and bottom 12 of the canister 10 are fixedly attached to the body 13. Such is preferably accomplished by welding, e.g., spot, sonic, or solvent welding.

Because many of the plastics to be used as the material for the canister 10 have a low density compared to that of the groundwater, preferably, the canister 10 is weighted. In a preferred embodiment, the bottom 12 is provided with an increased weight. This can be accomplished in any number of manners. For example, the density of the plastic material forming the bottom 12 may be greater. However, in a preferred embodiment, the bottom 12 has an area for receiving a weight (which can be as simple as a rock, a fishing weight, or a bag of ordinary sand). In one embodiment, the weight is integral with the canister 10 and in a most preferred embodiment, the weight is unitary with the canister. By providing the canister 10 with a weighted bottom 12, it can be assured that the OGM contained within the canister 10 is properly contacted, i.e., partially or completely submerged under the groundwater. In one embodiment, the weight added to the bottom 12 is calculated such that only a portion of the canister 10 is submerged when placed downhole. As the OGM inside the canister 10 is used up, the level to which the canister 10 is submerged will be closer to the bottom of the canister 10. If the density/mass of the groundwater on the one hand and the canister 10 on the other hand, as well as the density/mass (as well as the rate of consumption) of the OGM, the canister 10 can be advantageously weighted such that the submersion level moves up the height of the canister 10 at a controlled rate. In a preferred embodiment, the OGM includes a water-absorbing material, such that the OGM increases in mass to become water-logged during operation thereof.

In one embodiment, the OGM is in a powdered form, having an average particle size between 1μ and 10 cm. In other embodiments, however, the OGM is in a compacted solid form, which will react with the groundwater only at the outer surface thereof. Accordingly, the size of the apertures 14 is specifically selected such that the groundwater is permitted to wash into the canister 10 in order to contact the OGM, while hindering, if not completely preventing the OGM (in whatever form) from exiting the canister.

In order to assist in placing the canister 10 downhole and removing it when the OGM has been expended, the canister typically is provided with a loop 17, preferably attached to the top 11. This loop 17 can be attached to a rope or cable to raise and/or lower the canister 10. In one embodiment, the canister is provided with a second loop 17′, attached to the bottom 11. In such a configuration, multiple canisters 10 can be connected in series, with the loops 17 interconnected with a connector, such as a short rope or cable, connecting a loop 17′ of a first canister 10 to a loop 17 of a second canister 10.

The size, shape and position of the apertures 14 are particularly selected as to achieve a desired result with respect to contacting the groundwater with the OGM. For example, should it be desired that the OGM only contact a small volume of groundwater at any time, the apertures 14 can be small in both number and size. If for example, it is desired that the OGM react with the groundwater for an extended time before the treated groundwater/OGM combination exit the canister 10, there may be a number of larger apertures 14 positioned along the circumference of the body 13, however only near the top 11. As a result, the untreated groundwater can enter the canister 10 at the top, flow to the bottom 12 of the canister 10 where it reacts to the OGM contained therein, and slowly come back to the top 11 before being allowed to exit the canister 10.

Depending upon the condition and physical state of the OGM, the body 13 of the canister 10 can be open from 0.05% to 99.95% (where the open % is calculated as follows:

$$\frac{BSA - \sum MSA}{BSA} \times 100 ,$$

where BSA is the total surface area of the body, and MSA is the minimum cross-sectional area of each aperture 14). The embodiment shown in FIG. 1 has a relatively low open percent, e.g., less than about 10%, preferably less than about 8%, most preferably less than about 5%.

FIG. 2 shows a second embodiment for the body 13, where the apertures 14 are replaced with a grid 16, such that the body has a high open %. Essentially, the grid 16 is a material formed by intersecting plastic pieces to form a pattern of openings therein. As shown in FIG. 2, the grid 16 includes a series of repeating spaces in the grid 16 of substantially the same size and shape. However, it is within the scope of the invention to have the number and size of the spaces be less homogeneous, i.e., either changing in a gradient across the body 13, or randomly. In the embodiment of FIG. 2, the body 13 has an open percent greater than about 50%, preferably greater than about 60% and most preferably greater than about 70%.

In order to assist in lowering the canister 10 into the well, and to aid in positioning and lifting the canister 10 from the well, the canister 10 is typically provided with a lifting hook 17, at the top 11.

In a preferred embodiment, the OGM is contained in a sleeve or liner 18. The liner 18 is designed to allow for ingress of ground water and is typically formed from cotton or other water permeable material. By providing the OGM inside a liner 18, the canister 10 is more easily constructed than if the OGM were simply placed into the interior chamber of the canister 10. When such a liner 18 is used, the particular size/shape/position of the apertures 14 becomes less important.

The liner 18 is preferably a material having holes therein, allowing groundwater to pass through while limiting or preventing the OGM from passing through. The liner 18 can be used when the OGM is in a slurry, powder or solid form as described above. This liner 18 may be in the form of a woven or non-woven, flexible or rigid, cellulosic or plastic structure, which can allow groundwater to pass through, while substantially preventing escape of the OGM and permitting escape of the generated oxygen.

The canister 10 of the invention can also be used as a groundwater sampling device, such as a passive diffusion sampler. In this embodiment, the OGM includes or is replaced with a material which will absorb groundwater when the canister 10 is placed downhole. Once the OGM absorbs a groundwater sample, the canister 10 can be lifted out of the well and the absorbed groundwater removed from the OGM, by e.g., chemical processes, or physical squeezing.

It should be apparent that embodiments other than those specifically described above may come within the spirit and scope of the present invention. Hence, the present invention is not limited by the above description.

1. A non-metallic disposable canister having a body, a top and a bottom, for use in treating fluids:
an oxygen generating material (OGM) contained in a space defined by the top, bottom and body,
wherein the body is formed from a non-metallic material and is provided with at least one aperture, sized and shaped to permit groundwater to contact the OGM without allowing the OGM to exit the canister when the canister is placed downhole.

2. The canister of claim 1, wherein the top and the bottom are welded to opposite ends of the body.

3. The canister of claim 1, wherein the OGM is contained in a liner.

4. The canister of claim 1, wherein, the OGM comprises:
peroxide;
hydroxide; and
hydrated aluminosilicates.

5. The canister of claim 1, further comprising a hook, attached to the top.

6. The canister of claim 5, further comprising a rope or cable attached to the hook.

7. (canceled)

8. The canister of claim 7, wherein the body has an open % of less than about 10%.

9. The canister of claim 7, wherein the body has an open % of greater than about 50%.

10. The canister of claim 1, wherein the top, body and bottom are independently formed from a plastic material.

11. The canister of claim 10, wherein the plastic is selected from the group consisting of PVC, olefins and fluouropolymers.

12. A method of treating groundwater comprising:
positioning a canister in the groundwater, the canister being nonmetallic and having a body, a top and a bottom comprising:
an oxygen generating material (OGM) contained in a space defined by the top, bottom and body,
wherein the body is formed from a non-metallic material, the top and bottom are welded to opposite ends of the body, and the body is provided with at least one aperture, sized and shaped to permit groundwater to contact the OGM without allowing the OGM to exit the canister when the canister is placed downhole.

13. The method of claim 12, wherein the positioning comprises suspending the canister with a rope or cable.

14. The method of claim 12, wherein the canister is formed from a plastic.

15. A method of forming a canister for treating fluid comprising:
providing a canister, formed from a non-metallic material, having an interior space defined by a body, a top and a bottom, wherein the body has at least one aperture, sized and shaped to permit groundwater to enter the canister without allowing the substances within the canister to exit the canister when it is placed downhole;
introducing an oxygen generating material (OGM) into the space; and
welding at least one of the top and the bottom to the body.

16. The method of claim 15, wherein the introducing step comprises placing the OGM into a sleeve.

17. The method of claim 15, wherein the OGM is contained in a sleeve.

18. The method of claim 15, wherein the welding step comprises welding both of the top and the bottom to the body.

19. The method of claim 15, wherein the introducing step is performed prior to the welding step.

20. The method of claim 19, wherein the body of the canister of the providing step has one of the top and the bottom welded thereto.

21. A method of sampling groundwater comprising:
introducing a canister into the fluid to be sampled, the canister comprising:
a plastic body, having an interior space defined by a body, a top and a bottom; and
a fluid absorbing material contained in the space;
wherein the top and the bottom are welded to opposite ends of the body, and the body provided with at least one aperture, sized and shaped to permit groundwater to enter the canister is placed downhole;
at least partially submerging the canister in the groundwater, such that the groundwater contacts the absorbing material, and allowing the absorbing material to absorb a sample of the groundwater;
removing the canister from the groundwater; and
removing the groundwater sample from the absorbing material by a chemical process.

22. The canister of claim 1, wherein at least a portion of the canister is weighted.

23. The method of claim 17, wherein the OGM is prepackaged in the sleeve.
